(19) United States
(12) Patent Application Publication
(10) Pub. No.: US 2007/0162947 A1
(43) Pub. Date: Jul. 12, 2007

(54) Method of recording audio-visual content in a communication network

(75) Inventor: Christian Bertin, Rennes (FR)

Correspondence Address: COHEN, PONTANI, LIEBERMAN & PAVANE, 551 FIFTH AVENUE, SUITE 1210, NEW YORK, NY, 10176, US

(73) Assignee: France Telecom, Paris (FR)

(21) Appl. No.: 10/585,274

(22) PCT Filed: Dec. 24, 2004
(86) PCT No.: PCT/FR04/03388

§ 371 Date: Feb. 12, 2007

(30) Foreign Application Priority Data
Jan. 5, 2004 (FR) 0450011

(51) Int. Cl. H04N 7/16; H04N 7/173; H04N 5/445; G06F 13/00; G06F 3/00

(52) U.S. Cl. 725/134; 725/58; 725/142

(57) ABSTRACT

According to the invention, said communications network including at least one network recorder able to record audiovisual content broadcast on a plurality of broadcast channels, said audiovisual content being recorded at the request of a user having a communications terminal able to communicate with at least one network recorder, said method comprises the following steps: the network recorder identifying itself, indicating at least: a means of access to said recorder, a list of broadcast channels, the user selecting a network recorder able to record at least one required audiovisual content and connecting thereto using said access means in order to request the recording of said at least one audiovisual content, said request including an identification of the audiovisual content to be recorded, and the network recorder sending a response to the user's recording request containing, if the request is accepted, an identification of the accepted recording request for each content to be recorded. Application to remote recording of audiovisual content.

The present invention relates to a method of recording audiovisual content in a communications network.

One particularly advantageous application of the invention is the field of remote recording audiovisual content.

There are prior art methods for the remote recording of audiovisual content broadcast on broadcast channels of a communications network that consist in requesting a broadcast channel to broadcast a content selected by the user to a personal digital recorder (PDR) situated in the user's home, for example.

By way of example, users can find it necessary to use this kind of remote recording method if they are far from home and realize that they have forgotten to program a recording on a PDR while they were at home.

Using an office computer, mobile telephone, or personal digital assistant (PDA), a user can then program recording remotely by sending a request to the broadcast channel concerned.

However, although they meet this type of need well, the above prior art remote recording methods do not solve other problems associated with recording audiovisual content, in particular if the broadcast channel whose content the user would like to record cannot be received, for example because that channel is not part of the package to which the user subscribes or because the user's receiver can receive only one channel at a time and is being used by another person on another broadcast channel at the time the content that the user wishes to record is broadcast.

Thus the technical problem to be solved by the present invention is that of proposing a method of recording audiovisual content in a communications network that would enable users to record audiovisual content that they are unable to record directly on their own receivers, either because the content cannot be received thereby, or because a receiver is not designed to receive more than one broadcast channel at a time.

In accordance with the present invention, the solution to the stated technical problem consists in a method of recording audiovisual content in a communications network including at least one network recorder able to record audiovisual content broadcast on a plurality of broadcast channels, characterized in that said audiovisual content is recorded by a network recorder at the request of a user having a communications terminal able to exchange information with at least one network recorder via said communications network, said method comprising the following steps:
the network recorder declaring itself in the network, the declaration indicating at least:
   a means of access to said recorder,
   a list of broadcast channels whose broadcast audiovisual content can be recorded by the network recorder,
the user using a terminal to select a network recorder able to record at least one required audiovisual content and to connect thereto using said access means in order to request the recording of said at least one audiovisual content, said request including an identification of said at least one audiovisual content to be recorded that consists in a unique reference of said content and/or an identification of an instance of said content consisting of at least the identification of the broadcast channel of said instance accompanied by the indication of a broadcast time band, and
the network recorder sending a response to the user's recording request containing, if the request is accepted, an identification of the accepted recording request for each content to be recorded.

Accordingly, from a PDR, a personal computer, a mobile telephone, or a personal assistant, a user can at any time request the network recorder to record an audiovisual content on any broadcast channel, even those channels to which the user does not have direct access, in order afterwards to transfer the recorded audiovisual content to the receiver of the user's choice (PDR, PC, PDA) and to watch it at a time when the receiver is available.

According to the invention, said time band indication includes the broadcast start time and either the broadcast end time or the duration of the broadcast on the broadcast channel of said instance.

The invention provides two main ways to access a network recorder. One way to access a network recorder is to use an address of said recorder in the network. The other way to access a network recorder is to use a directory listing operations specific to the network recorders, each network recorder being identified by said operation.

More precisely, according to the invention, said list of broadcast channels whose broadcast audiovisual content the network recorder can record includes the address of each broadcast channel, optionally accompanied by the charging policy of the network recorder for each broadcast channel. The broadcast channel address is a channel identifier codified by a consortium combining interested companies and organizations, such as the TV Anytime forum.

To enable the user to receive the audiovisual content recorded by the network recorder subject to technical conditions compatible with the user's receiver, the invention provides for the declaration of the network recorder in the network to contain the conversion capabilities of said recorder, which relate more particularly to bit rate reduction and/or transcoding of the audiovisual content.

It should also be pointed out that the bit rate and transcoding constraints in respect of the audiovisual content emanate from the user himself, as the invention teaches that said request should contain the conversion capabilities required by the user for transferring the recording to the user's terminal.

Likewise, the invention provides for the declaration of the network recorder in the network to contain the protocols that the network recorder can use to transfer the recorded audio visual content to the user's terminal. In other words, this enables the user to select either a streaming direct transfer mode or a downloading mode (off-line relative to recording in the network).

When it receives a recording request, the network recorder supplies a response to the user who sent the request.

If the request fails and plurality of contents has been requested, the response of the network recorder to the user's recording request contains a rejected content identification. Likewise, the response of the recorder includes the reason for failure, for example the fact that the network recorder does not have access to the content requested by the user.

If the request is accepted, the invention envisages a number of options in addition to identification of the accepted request, namely: the response from the network recorder contains said unique reference of the requested audiovisual content, the response from the network recorder contains the programmed end of recording time and/or the cost of said recording, or the response from the network recorder contains the time for which the network recorder will keep the recording.

The recording method of the invention also offers the user the option to review and revise a request, by said method further including the steps of the user formulating a request to cancel a recording request that has been accepted or to delete a content that has been recorded by the network recorder, that request specifying at least the identification of the recording request that has been accepted.

To enable the user to determine at any time the stage reached by the network recorder in processing a request, the recording method of the invention also include the steps of:
for the user, if the request is accepted, sending the network recorder a recording request status request indicating at least said identification of the accepted recording request, and
for the network recorder, sending a response to the recording request status request containing at least the identification of the accepted recording request and the status of the request.

Said recording request status request preferably contains said unique reference of the content and/or the identification of the user.

The response of the recorder to the recording request status request may take various forms, depending on the situation:
in the case of a request that has not yet been executed, the response to the recording request status request contains the unique reference of the content and/or the programmed end date and time,
in the event of an unknown request, the response to the recording request status request contains the unique reference of the content,
in the event of failure of the request, the response to the recording request status request contains the unique reference of the content,
if the content is available, the response to the recording request status request contains an address at which the recorded content is available. In which case, the response contains the unique reference of the content and/or the time for which the network recorder will keep the recording.

The following description with reference to the appended drawings, which are provided by way of non-limiting example, explains in what the invention consists and how it may be reduced to practice.

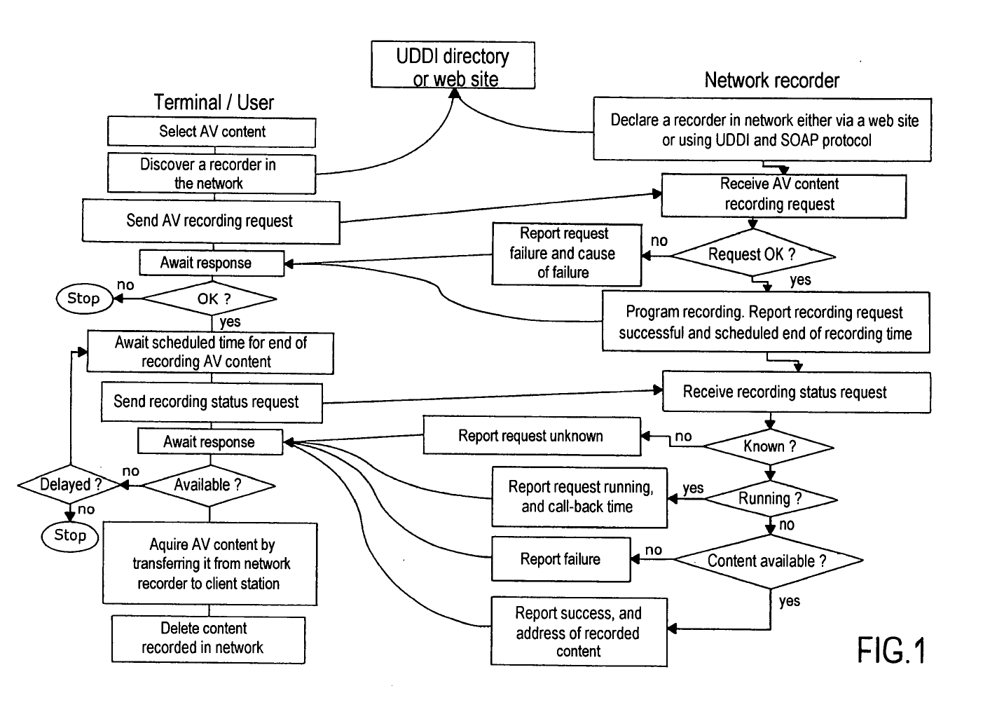

FIG. 1 is a general flowchart of the recording method of the invention.

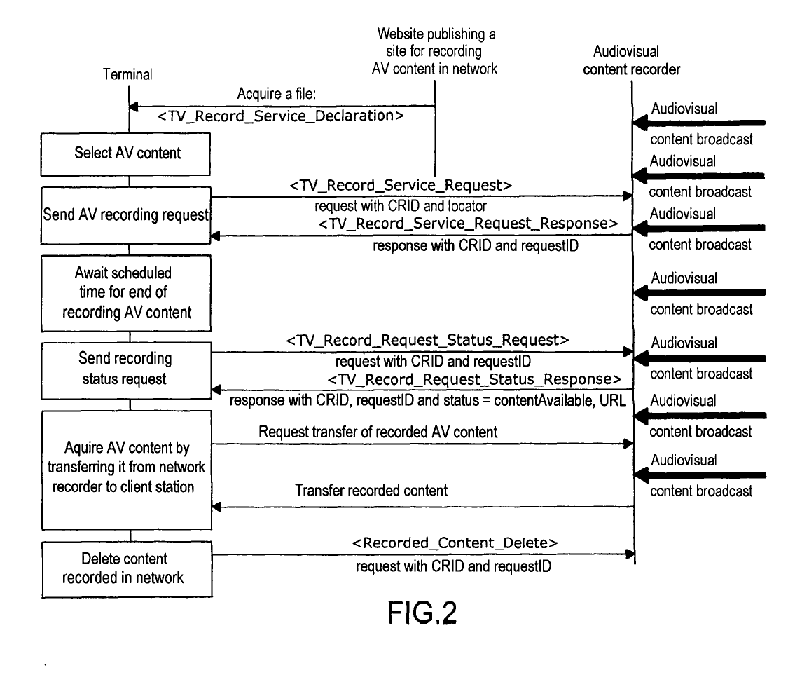

FIG. 2 is a flowchart of the recording method of the invention in the case of a successful recording request.

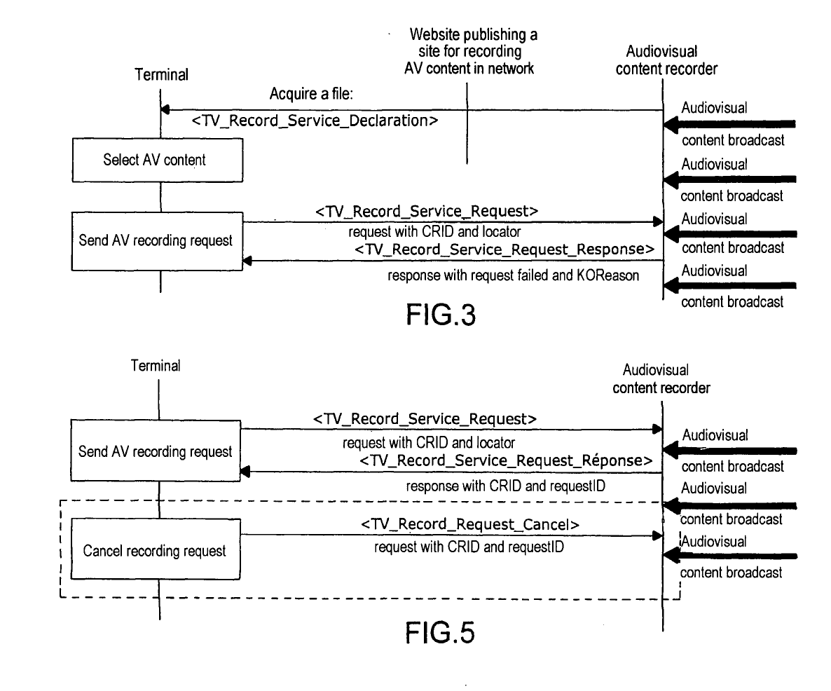

FIG. 3 is a flowchart of the recording method of the invention in the case of a failed recording request.

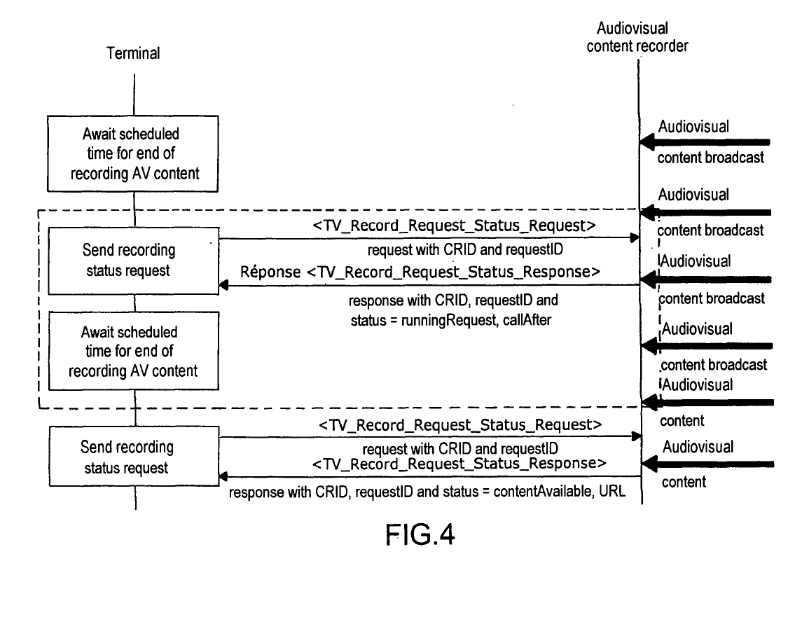

FIG. 4 is a flowchart of the recording method of the invention in the case of a successful recording request with additional time-delay.

FIG. 5 is a flowchart of the recording method of the invention in the case of a successful recording request followed by a cancellation request.

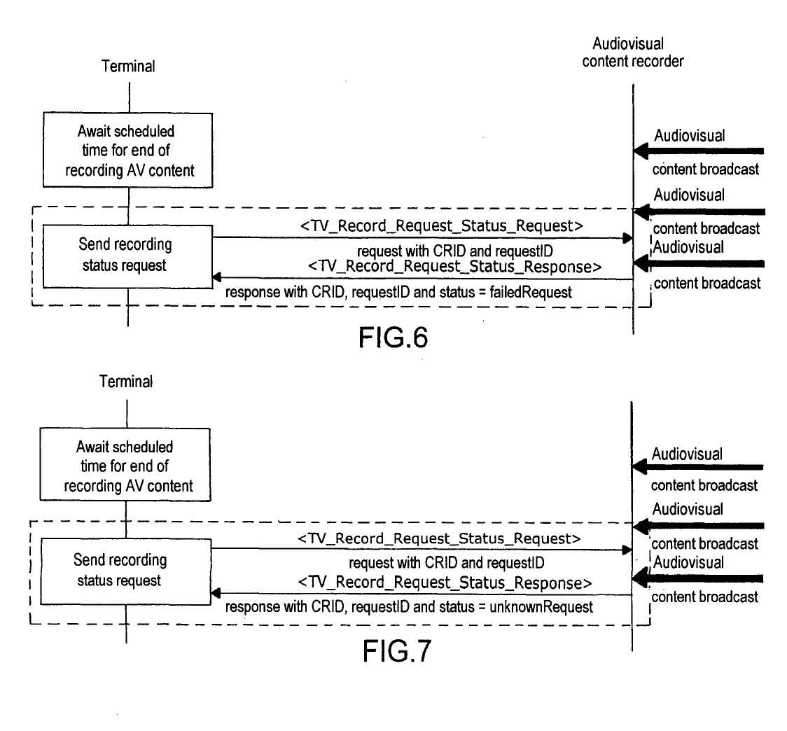

FIG. 6 is a flowchart of the recording method of the invention in the case of a successful recording request followed by a failure to record.

FIG. 7 is a flowchart of the recording method of the invention in the case of an unknown recording request.

FIG. 1 is a general flowchart of a method of recording audiovisual (AV) content in a communications network.

That method involves at least one network recorder, corresponding to the right-hand portion of FIG. 1, able to record audiovisual content broadcast on broadcast channels. Network recorder operators offer a user the service of recording on their behalf audiovisual content that they are unable to record themselves, for example because this is not possible as the user does not have an appropriate subscription or does not have access to the broadcast channel that is broadcasting the required AV content or because their receiver is already being used by another person on another broadcast channel. Network recorders can be provided by operators specializing in this type of service or by the broadcast channels (television channels) themselves.

The network recorder records an audiovisual content at the request of a user, corresponding to the left-hand portion of FIG. 1, provided with a terminal able to exchange information concerning recording requests with network recorders via a communications network.

Initially, the network recorders must declare themselves on the communications network, either directly through a recorder website or indirectly via a directory, for example a UDDI (Universal Description Discovery and Integration) directory associated with the SOAP (Simple Object Access Protocol) exchange technology. In which case, the directory has to create a particular “Network Recorders” heading and list in the directory under that heading the network recorders that have been declared.

The declaration of the existence each network recorder in the network (<TV_Record_Service_Declaration> data structure) indicates:
preferably, an address of the network recorder (<RecordServiceAddress> element), which is the address to which the recording request must be sent, and is either the address of a website or the address of a directory heading,
preferably, a list of the broadcast channels that it can record (<DeliveryServiceList> element), able to contain for each channel:
   preferably, the address of the broadcast channel (“serviceURL” attribute), for example as defined by the TV Anytime forum,
   optionally, the charging policy of the recorder for that broadcast channel (<ChargingPolicy> element),
optionally, the conversion capabilities of the recorder (<ConversionCapabilities> element) consisting of:
   the bit rate reduction capability (<BitrateConversionCapability> element), for example bit rate reduction from 4 Mbps to 2 Mbps,
   the ability to transcode the audiovisual content (<TranscodingCapability> element) into different audiovisual coding formats, such as MPEG2 to MPEG4 transcoding,
   optionally, the protocols supported for transferring the recorded AV content to the user's receiver: FTP, streaming, or downloading.

The user must be in a position to discover the existence of network recorders in order to be able to select the one able to record the required AV content under the best technical, economic and ergonomic conditions. This can be done:
either by defining a particular MIME (Multipurpose Internet Mail Extensions) type (e.g. “application/x-TV-Record-Service-Declaration”), which, when a file of this type is received from a website, activates software on the user's receiver for interpreting the <TV_Record_Service_Declaration> data structure defined above,
or by using a UDDI directory and defining a new “tModel” for AV content recording services enabling any recorder to declare its existence and its capabilities to the directory in the <TV_Record_Service_Declaration> data structure defined above.

Having selected the best-suited network recorder for recording the required AV content from a website or a directory, the user sends that recorder a recording request (<TV_Record_Service_Request> data structure) comprising:
preferably, the identification of the user (<UserId> attribute) if the user has not been identified some other way, for example at the time of connecting to the recorder (log in and password type connection),
preferably, an identification of the AV content to be recorded, which may be:
   either a unique reference of said content (“CRID” attribute), essentially a simple identification of the content as such,
   or the user's own identification of an instance of that content consisting of:
      preferably, the identification of the broadcast channel (“serviceURL” attribute),
      preferably, the start time (“start” attribute),
      preferably, the end time (“end” attribute) or the duration (“duration” attribute),
      optionally, the identification of a particular instance (“instanceMetadataId” attribute),
optionally, the conversion capabilities required by the user.

The network recorder's response to the user's recording request (<TV_Record_Service_Request_Response> data structure) contains for each content to be recorded an indication:
either of the success of the recording request (<RecordRequestSuccess> element), this indication containing:
   preferably, the identification of the accepted recording request (“requestId” attribute),
   optionally, the identification of the requested content (“CRID” attribute),
   optionally, the programmed end of recording time (“recordEndTime” attribute),
   optionally, the time to keep the recorded content (“keepDuration” attribute),
   optionally, the cost of the recording (“recordCost” and “currency” attributes),
or of the failure of the recording request (<RecordRequestFailure> element), this indication containing:
   preferably, the identification of the requested content (“CRID” attribute),
   optionally, the reason for failure of the request (“KOreason” attribute).

If a recording request is accepted, its status can be requested (<TV_Record_Request_Status_Request> data structure), the request indicating:
preferably, the identification of the accepted recording request (“requestId” attribute),
optionally, the identification of the content to be recorded (“CRID” attribute),
optionally, the identification of the user (<UserId> attribute).

On receiving a request status request, the network recorder sends a response (<TV_Record_Request_Status_Response> data structure) containing:
in the case of a request that has not yet been executed:
   preferably, the identification of the accepted recording request (“requestId” attribute),
   preferably, the status of the request (“status” attribute, “runnningRequest” value),
   optionally, the identification of the content to be recorded (“CRID” attribute),
   optionally, the programmed end date and time (“callAfter” attribute),
in the case of an unknown request (<<requestID>> attribute not recognized):
   preferably, the identification of the accepted recording request (“requestId” attribute),
   preferably, the status of the request (“status” attribute, “unknownRequest” value),
   optionally, the identification of the content to be recorded (“CRID” attribute),
in the case of a request that fails (for example in the event of an equipment failure):
   preferably, the identification of the accepted recording request (“requestId” attribute),
   preferably, the status of the request (“status” attribute, “failedRequest” value),
   optionally, the identification of the content to be recorded (“CRID” attribute),
in the case of a request that has been completed with the recorded content available:
   preferably, the identification of the accepted recording request (“requestId” attribute),
   preferably, the status of the request (“status” attribute, “contentAvailable” value),
   preferably, the means of recovering the recorded content (“contentURL” attribute),
   optionally, the identification of the content to be recorded (“CRID” attribute),
   optionally, the time for which the recorder will keep the recorded content (“keepDuration” attribute).

The user can also request cancellation of a recording request (<TV_Record_Request_Cancel> data structure), for example if the user changes his or her mind, the cancellation request indicating:
preferably, the identification of the accepted recording request (“requestId” attribute),
optionally, the identification of the content to be recorded (“CRID” attribute),
optionally, the identification of the user (<UserId> attribute).

The user can also request the deletion of an AV content that has already been recorded in the network (<Recorded_Content_Delete> data structure), the deletion request indicating:
preferably, the identification of the accepted recording request (“requestId” attribute),
optionally, the identification of the content to be recorded (“CRID” attribute),
optionally, the identification of the user (<UserId> attribute).

The steps of the recording method that have just been generally described with reference to FIG. 1 will now be described in more detail with reference to FIGS. 2 to 7.

1. Recording Audiovisual Content in the Network from a Network Recorder Website.

1.1. Discovering a Network Recorder Website.

An audiovisual content recorder can make itself known by means of an HTML page on a website.

On clicking on a link indicated on the web page, the user's terminal receives a file of a particular MIME type: “application/x-TV-Record-Service-Declaration”.

This file contains the following information:
preferably, the address of the recorder on the network (<RecordServiceAddress> element),
preferably, a list of the channels that it can record (<DeliveryServiceList> element) containing for each channel:
   preferably, the address of the channel as defined by the TV Anytime forum (“serviceURL” attribute),
   optionally, the charging policy of the recorder for that channel (<ChargingPolicy> element),
optionally, the conversion capabilities of the recorder (<ConversionCapabilities> element), consisting of:
   a bit rate reduction capability (<BitrateConversionCapability> element),
   an audiovisual content transcoding capability (<TranscodingCapability> element) relating to transcoding a content into different audiovisual coding formats,
optionally, the protocols supported for transferring the recorded content to the user's terminal (e.g. only the FTP mode or another mode is always proposed by default).

There follows an example of a file declaring a recorder in the network:

<TV_Record_Service_Declaration xmlns:xsi=“http://www.w3.org/2001/XMLSchema-instance”
xsi:noNamespaceSchemaLocation=“TVRecServ.xsd” version=“1”>

<RecordServiceAddress>http://www.voila.fr/RecordRequest.rr</RecordServiceAddress>
<ConversionCapabilities>

<BitrateConversionCapability>true</BitrateConversionCapability>
<TranscodingCapability>MPEG-1</TranscodingCapability>
<TranscodingCapability>MPEG-4</TranscodingCapability>

</ConversionCapabilities>
<SupportedTransferProtocols>

<SupportedTransferProtocol value=“FTP”/>
<SupportedTransferProtocol value=“HTTP”/>

</SupportedTransferProtocols>
<DeliveryServiceList>

<DeliveryService serviceURL=“dvb://1.2.a”>

<ChargingPolicy xml:lang=“en”>3 USD for AV contents produced in the last 3 months, 1 USD for

the other contents</ChargingPolicy>

</DeliveryService>
<DeliveryService serviceURL=“dvb://1.2.b”/>
<DeliveryService serviceURL=“dvb://1.2.c”/>

</DeliveryServiceList>

</TV_Record_Service_Declaration>

This table is used to declare a broadcast audiovisual content recorder to which requests may be submitted at the address indicated by the <RecordServiceAddress> element for content delivery services or broadcast channels (television channels) indicated by the <DeliveryServiceURL> elements.

Accordingly, if the user wishes to record a content broadcast by one of the broadcast channels declared in this way, if the user's terminal does not receive the channel broadcasting the selected content directly or is unable to receive it at the time the content is broadcast, it can request the recording of that content at the address indicated in the <RecordServiceAddress> element.

1.2. Requesting by the User of Recording in the Network.

When a user has discovered in the preceding step that a network recorder is able to record audiovisual content broadcast by a particular broadcast channel and the user wishes to activate a network recorder, the user must send it the request <TV_Record_Service_Request>, at the address indicated by the <RecordServiceAddress> element of the above table, with the following information:
preferably, the identification of the user (“UserId” attribute),
optionally, the identification of the protocol to be used to transfer the content after recording,
optionally, the identification of the coding required for the content to be recorded (which may call for transcoding in the recorder),
preferably, the identification of the content to be recorded (“CRID” attribute),
optionally, the identification of an instance of that content consisting of:
   preferably, the identification of the television channel (“serviceURL” attribute),
   preferably, the start time (“start” attribute),
   preferably, the end time (“end” attribute) or the duration (“duration” attribute),
   optionally, the identity of a particular instance (“instanceMetadataId” attribute).

There follows an example of a file requesting recording in the network of two contents using FTP as the recorded content recovery protocol and transcoding to MPEG-4 with a maximum bit rate of 1500 kbps for the “crid://hbc.com/foxes/episode11” content on the television channel “dvb://1.4ee2.3f5/” and the “crid://ch1.com/serie/ep12” content on the channel “dvb://1.4ee2.3f4;4f5/”:

<TV_Record_Service_Request xmlns:xsi=“http://www.w3.org/2001/XMLSchema-instance”
xsi:noNamespaceSchemaLocation=“TVRecServ.xsd” userId=“X3YZDFdeGH49”>

<RequestedTransferProtocol>FTP</RequestedTransferProtocol>
<Transcoding>MPEG-4</Transcoding>
<MaxBitRate>1500</MaxBitRate>
<ContentIdentification crid=“crid://hbc.com/foxes/episode11” serviceURL=“dvb:// 1.4ee2.3f5/” start=“2001-

04-07T19:00:00.00+01:00” duration=“PT1H30M”/>

<ContentIdentification crid=“crid://ch1.com/serie/ep12” serviceURL=“dvb://1.4ee2.3f4;4f5/” start=“2003-06-

27T12:30:00.00+01:00” duration=“PT0H30M” instanceMetadataId=“imi:broadcast/1”/>
</TV_Record_Service_Request>

Each content to be recorded is identified by its CRID, the serviceURL that will deliver the content, its start time and its duration (or its end time), and where applicable its instance identification.

The response <TV_Record_Service_Request_Response> received in return indicates for each content whose recording has been requested:
either the success of the recording request (<RecordRequestSuccess> element) (FIG. 2), giving:
   preferably, the identification of the accepted recording request (“requestId” attribute),
   preferably, the identification of the requested content (“CRID” attribute), if a plurality of contents was requested in the same request,
   optionally, the identification of the requested content (“CRID” attribute), if a single content was requested,
   optionally, the programmed end of recording time (“recordEndTime” attribute),
   optionally, the time to keep the recorded content (“keepDuration” attribute),
   optionally, the recording cost (“recordCost” and “currency” attributes),
or the failure of the recording request (<RecordRequestFailure> element) (FIG. 3), giving:
   preferably, the identification of the content for which the request has failed (“CRID” attribute), if a plurality of contents was requested in the same request,
   optionally, the identification of the requested content (“CRID” attribute), if a single content was requested,
   optionally, the reason for failure of the request (“KOreason” attribute).

There follows an example of a response to a recording request with success for two contents (the time to keep and the cost to be paid the being indicated for the second one) and failure for two others:

<TV_Record_Service_Request_Response xmlns:xsi=“http://www.w3.org/2001/XMLSchema-instance”
xsi:noNamespaceSchemaLocation=“TVRecServ.xsd”>
<RecordRequestSuccess crid=“crid://hbc.com/foxes/episode11” requestId=“12456XD34”
recordEndTime=“2003-04-07T20:30:00.00+01:00”/>
<RecordRequestSuccess crid=“crid://zzz.com/movie/title1” requestId=“156WQ77” recordEndTime=“2003-04-
07T20:30:00.00+01:00” keepDuration=“PT24H” recordCost=“2” currency=“USD”/>
<RecordRequestFailure crid=“crid://ch1.com/serie/ep12” KOreason=“unknownCRID”/>
<RecordRequestFailure crid=“crid://chaine5.com/film15” KOreason=“unavailableServiceURL”/>
</TV_Record_Service_Request_Response>

1.3. Management of a Request for Recording in the Network.

After accepting a request for recording in the network, the network recorder is able to monitor changes in the scheduling of the broadcasting of AV contents and to reprogram the recording of the requested contents accordingly.

After a request for recording in the network is accepted, the user has a number of options:
to cancel the recording request (if the cost is too high or the user changes his or her mind),
to track the status of a recording request (to find out if the content has been reprogrammed at another date or time, or if the recording is finished).

To cancel a recording request, the user must send a recording request cancellation request (<TV_Record_Request_Cancel> date structure) (FIG. 5) containing:
preferably, the identification of the accepted recording request (“requestId” attribute),
optionally, the identification of the content to be recorded (“CRID” attribute),
optionally, the identification of the user (<UserId> attribute).

There follows an example of a recording request cancellation request:

<TV_Record_Request_Cancel xmlns:xsi=“http://www.w3.org/2001/XMLSchema-instance”
xsi:noNamespaceSchemaLocation=“TVRecServ.xsd” crid=“crid://hbc.com/foxes/episode11”
requestId=“12456XD34”/>

No response is expected from the recorder.

To track the status of a recording request, the user must send a recording request status request (<TV_Record_Request_Status_Request> data structure) (FIG. 2) containing:
preferably, the identification of the accepted recording request (“requestId” attribute),
optionally, the identification of the content to be recorded (“CRID” attribute),
optionally, the identification of the user (<UserId> attribute).

There follows an example of a “recording status request” request:

<TV_Record_Request_Status_Request xmlns:xsi=“http://www.w3.org/2001/XMLSchema-instance”
xsi:noNamespaceSchemaLocation=“TVRecServ.xsd” crid=“crid://hbc.com/foxes/episode11”
requestId=“12456XD34”/>

Several responses are possible. If the content has not yet been recorded (FIG. 4), the response from the recorder includes:
preferably, the identification of the accepted recording request (“requestId” attribute),
preferably, the status of the request (“status” attribute, “runnningRequest” value),
optionally, the identification of the content to be recorded (“CRID” attribute),
optionally, the programmed end date and time (“callAfter” attribute).

There follows an example of a “content not yet recorded” response:

<TV_Record_Request_Status_Response xmlns:xsi=“http://www.w3.org/2001/XMLSchema-instance”
xsi:noNamespaceSchemaLocation=“TVRecServ.xsd” crid=“crid://hbc.com/foxes/episode11”
requestId=“12456XD34” status=“runningRequest” =“2003-06-27T14:30:00.00+01:00”/>

The “callAfter” attribute enables the terminal to program a timer for repeating a recording status request if there is any chance of obtaining a different response. This is the case if the broadcast time of a content has changed.

If the request is not recognized as valid (FIG. 7), the response from the recorder includes:
preferably, the identification of the accepted recording request (“requestId” attribute),
preferably, the status of the request (“status” attribute, “unknownRequest” value),
optionally, the identification of the content to be recorded (“CRID” attribute).

There follows an example of an “unknown recording request” response:

<TV_Record_Request_Status_Response xmlns:xsi“http://www.w3.org/2001/XMLSchema-instance”
xsi:noNamespaceSchemaLocation=“TVRecServ.xsd” crid=“crid://hbc.com/foxes/episode11”
requestId=“12456XD34” status=“unknownRequest”/>

This situation can arise if the user's terminal interrogates the network recorder after the end date for keeping a recorded content.

If the request has failed (FIG. 6), the recorder responds with:
preferably, the identification of the accepted recording request (“requestId” attribute),
preferably, the status of the request (“status” attribute, “failedRequest” value),
optionally, the identification of the content to be recorded (“CRID” attribute).

There follows an example of a “failed recording request” response:

<TV_Record_Request_Status_Response xmlns:xsi=“http://www.w3.org/2001/XMLSchema-instance”
xsi:noNamespaceSchemaLocation=“TVRecServ.xsd” crid=“crid://hbc.com/foxes/episode11”
requestId=“12456XD34” status=“failedRequest”/>

If recording has finished and the content is available, the response from the recorder includes:
preferably, the identification of the accepted recording request (“requestId” attribute),
preferably, the status of the request (“status” attribute, “contentAvailable” value),
optionally, the identification of the content to be recorded (“CRID” attribute),
optionally, the time to keep the recorded content in the recorder (“keepDuration” attribute),
preferably, the means of recovering the recorded content (“contentURL” attribute).

There follows an example of a “recorded content available in the recorder” response:

<TV_Record_Request_Status_Response xmlns:xsi=“http://www.w3.org/2001/XMLSchema-instance”
xsi:noNamespaceSchemaLocation=“TVRecServ.xsd” crid=“crid://hbc.com/foxes/episode11”
requestId=“12456XD34” status=“contentAvailable”
contentURL=“ftp://login:password@ftp.tvrs.fr/user1/av12.mpg”/>

1.4 Transferring and Deleting a Content Recorded in the Network.

If the recorder responds to a content recording request status request by indicating that the content is available, the user's terminal can then download the content, the address of the content being indicated by the <contentURL> attribute of the response from the recorder.

The recording will be deleted automatically after a certain time or in response to a specific request from the terminal containing:
preferably, the identification of the accepted recording request (“requestId” attribute),
optionally, the identification of the content to be recorded (“CRID” attribute),
optionally, the identification of the user (<UserId> attribute).

There follows an example of a request to delete a recording:

<Recorded_Content_Delete xmlns:xsi=“http://www.w3.org/2001/XMLSchema-instance”
xsi:noNamespaceSchemaLocation=“TVRecServ.xsd” crid=“crid://hbc.com/foxes/episode11”
requestId=“12456XD34”/>

No response is expected from the recorder.

2. Recording of an Audiovisual Content by a Network Recorder Using UDDI and SOAP.

2.1 Declaring the Network Recorder Using UDDI (Web Service).

The technology of web services and in particular of UDDI (Universal Description, Discovery and Integration) services enables recorders of audiovisual content broadcast in the network by broadcast channels to be entered into a directory: the UDDI directory.

The SOAP (Simple Object Access Protocol) technology is used to exchange XML-type data structures.

It must be possible to record in the UDDI directory:
a new service category (or heading): the service for recording audiovisual content in the network with its access point and the operations accepted from users' terminals,
a search criterion: the identifier of each broadcast channel (television channel).

Thus a user terminal looking for a network recorder can consult the directory, supplying one or more broadcast channel (television channel) identifiers and requesting in return a means of addressing directly recorders that satisfy the search criteria.

The new search criterion in the UDDI directory that consists of the television channel identifier, for example, must be the subject of the definition of a new UDDI tModel, here called “serviceURL” (in conformance with section 1.6.4 of the UDDI specifications relating to the definition of “tModel”), to declare the audiovisual content broadcast channels. It is given the name “tv-record-org:serviceURL”. This is an authority that must request the recording of this new “tModel”. The entity “tv-record-org” is any entity, for example “tv-Anytime-org”. This leads to declaring a key with the same name “uddi:tv-record.org:serviceURL”.

The declaration of that key also includes references to the specifications of this “tModel” by the organization requesting its insertion “<overviewDoc><overviewURL>” and the “<categoryBag>” element contains standard information included in any “tModel” declaration.

<tModel tModelKey=“uddi:tv-record.org:serviceURL”>

<name>tv-record-org:serviceURL</name>
<description xml:lang=“en”>Category system for each delivery service handled by a recording

service</description>

<overviewDoc>

<overviewURL useType=“text”>

ftp://pub:pub@ftp.francetelecom.fr/pub/Spec/Record_tModel.zip

</overviewURL>

</overviewDoc>
<categoryBag>

<keyedReference keyName=“uddi-org:types:categorization”

keyValue=“categorization” tModelKey=“uddi:uddi.org:categorization:types”/>

<keyedReference keyName=“uddi-org:types:unchecked”

keyValue=“unchecked” tModelKey=“uddi:uddi.org:categorization:types”/>

</categoryBag>

</tModel>

It is also necessary to define a “tModel port” for sending requests to the audiovisual content recorder as follows: this “tModel” describes the service for transferring “submit_Data” requests to the content recorder in the network, the use of which will be illustrated later:

<tModel tModelKey=“uddi:tv-record.org:submit_Data_v10”>

<name>tv-record-org:submit_Data_v10</name>
<description xml:lang=“en”>TV Record WSDL interface for submit_Data port</description>
<overviewDoc>

<overviewURL useType=“wsdlInterface”>
http://www.tv-record.org/wsdl/tvr_transport_v10.wsdl#submit_Data_SOAP
</overviewURL>

</overviewDoc>
<overviewDoc>

<overviewURL useType=“text”>

ftp://tvr:tvr@ftp.voila.fr/spec/tvr_xxV10.zip

</overviewURL>

</overviewDoc>
<categoryBag>

<keyedReference keyName=“uddi-org:types:wsdl” keyValue=“wsdlSpec”

tModelKey=“uddi:uddi.org:categorization:types”/>

<keyedReference keyName=“uddi-org:types:soap” keyValue“soapSpec”

tModelKey=“uddi:uddi.org:categorization:types”/>

<keyedReference keyName=“uddi-org:types:xml” keyValue=“xmlSpec”

tModelKey=“uddi:uddi.org:categorization:types”/>

<keyedReference keyName=“uddi-org:types:specification”

keyValue=“specification” tModelKey=“uddi:uddi.org:categorization:types”/>
</categoryBag>

</tModel>

To make itself known, a broadcast audiovisual content recorder must declare its recording capabilities using the “save_binding” method (see the UDDI API publication), assuming that the appropriate parental structures “businessEntity” and “businessService” have already been declared, referring to the “tModel” defined previously:

<save_binding xmlns=“urn:uddi-org:api_v3”>

<bindingTemplate>

<description xml:lang=“fr”>Declaration of an audiovisual content recording service for one or more

television channels </description>

<accessPoint useType=“endPoint”>

http://www.voila.fr/movies

</accessPoint>
<tModelInstanceDetails>

<tModelInstanceInfo tModelKey=“uddi:tv-record.org:submit_Data_v10”>

<instanceDetails>

<instanceParms><![CDATA[

<?xml version=“1.0” encoding=“utf-8”?>

<describe_submit_Data_Result serviceVersion=“3”

xmlns=“http://www.tv-anytime.org/2002/11/transport”>

<ConversionCapabilities>

<BitrateConversionCapability>true</BitrateConversionCapability>
<TranscodingCapability>MPEG-1</TranscodingCapability>
<TranscodingCapability>MPEG-4</TranscodingCapability>

</ConversionCapabilities>
<SupportedTransferProtocols>

<SupportedTransferProtocol value=“FTP”/>
<SupportedTransferProtocol value=“HTTP”/>

</SupportedTransferProtocols>
<DeliveryServiceList>

<DeliveryService serviceURL=“dvb://1.2.a”>

<ChargingPolicy xml:lang=“en”>3 USD for AV contents produced in the last 3 months, 1 USD for the other

contents</ChargingPolicy>

</DeliveryService>
<DeliveryService serviceURL=“dvb://1.2.b”/>
<DeliveryService serviceURL=“dvb://1.2.c”/>

</DeliveryServiceList>

</describe_submit_Data_Result>

]]></instanceParms>

</instanceDetails>

</tModelInstanceInfo>

</tModelInstanceDetails>
<categoryBag>

<keyedReference tModelKey=“uddi:tv-record.org:serviceURL”

keyValue=“dvb://1.2.a”/>

<keyedReference tModelKey=“uddi:tv-record.org:serviceURL”

keyValue=“dvb://1.2.b“/>

<keyedReference tModelKey=“uddi:tv-record.org:serviceURL”

keyValue=“dvb://1.2.c”/>

</categoryBag>

</bindingTemplate>

</save_binding>

The <accessPoint> element provides the HTTP address of the recorder to which the “submit_Data” request must be sent.

The <instanceParms> element contains the declaration of what may be expected of the recorder (content of the data structure <TV_Record_Service_Declaration> defined for the first embodiment) which defines the transcoding, bit rate production and transfer protocol capabilities, the list of recordable broadcast channels and the charging policy.

The <categoryBag> element contains a list of the broadcast channels that the recorder is able to record.

2.2 Discovering a Network Recorder Using a Web Service.

The technology of web services and of UDDI

(Universal Description, Discovery and Integration) services in particular also offers terminals the option, if they have an Internet connection, of discovering broadcast audiovisual content recorders by consulting the directory, without necessitating any prior knowledge.

Thus any terminal can use a node of the UDDI business directory (which has well known addresses) to find broadcast individual content recorders using the <find_binding> command as shown below:

<find_binding xmlns=“urn:uddi-org:api_v3”>

<tModelBag>

<tModelKey>uddi:tv-record.org:submit_Data_v10</tModelKey>

</tModelBag>
<categoryBag>

<keyedReference tModelKey=“uddi:tv-record.org:serviceURL”

keyValue=“dvb://1.2.a”/>

<keyedReference tModelKey=“uddi:tv-record.org:serviceURL”

keyValue=“dvb://1.2.c”/>

</categoryBag>

</find_binding>

In this example, the terminal is looking for a network recorder for the channels or television channels “dvb://1.2.a” and “dvb:/1.2.c”.

In response, the terminal receives a <bindingTemplate> list that matches its request (recorded in the directory of services by the command <save_binding>).

2.3 Requesting Recording in the Network

After choosing an audiovisual content recorder, the terminal can send the following request using the SOAP (Simple Object Access Protocol) to request the recording of a content (the request encapsulating the 5<TV_Record_Service_Request> request defined in the preceding embodiment):

POST /tvr/md-service HTTP/1.0
Host: www.voila.fr
Content-Type: text/xml; charset=“utf-8”
Content-Length: nnnn
Accept-Encoding: deflate
SOAPAction: “submit_Data”
<?xml version=“1.0” encoding=“UTF-8”?>
<Envelope xmlns=“ http://schemas.xmlsoap.org/soap/envelope/”>

<Body>

<submit_Data xmlns=“http://www.tv-record.org/2002/11/transport”>

<TV_Record_Service_Request

xmlns:xsi=“http://www.w3.org/2001/XMLSchema-instance”
xsi: noNamespaceSchemaLocation=“TVRecServ.xsd” userId“XcGHJ63DX”>
<RequestedTransferProtocol>FTP</RequestedTransferProtocol>
<Transcoding>MPEG-4</Transcoding>
<MaxBitRate>1500</MaxBitRate>
<ContentIdentification crid=“crid://hbc.com/foxes/episode11”

serviceURL=“dvb://1.4ee2.3f5/”
start=“2001-04-07T19:00:00.00+01:00” duration=“PT1H30M”/>
<ContentIdentification crid=“crid://ch1.com/serie/ep12”

serviceURL=“dvb://1.4ee2.3f4;4f5/”
start=“2003-06-27T12:30:00.00+01:00” duration=“PT0H30M”
instanceMetadataId=“imi:broadcast/1”/>

</TV_Record_Service_Request>

</submit_Data>

</Body>

</Envelope>

In return the terminal receives the following response for recording requests that have succeeded and other recording requests that have failed:

HTTP/1.1 200 OK
Content-Type: text/xml; charset=“utf-8”
Content-Length: nnnn
Content-Encoding: deflate
<?xml version=“1.0” encoding=“UTF-8”?>
<Envelope xmlns=“http://www.w3.org/2002/06/soap-envelope”>

<Body>

<submit_Data_Result xmlns=“ http://schemas.xmlsoap.org/soap/envelope/”>

<TV_Record_Service_Request_Response

xmlns:xsi=“http://www.w3.org/2001/XMLSchema-instance”
xsi:noNamespaceSchemaLocation=“TVRecServ.xsd”>
<RecordRequestSuccess crid=“crid://hbc.com/foxes/episode11”

requestId=“12456XD34”
recordEndTime=“2003-04-07T20:30:00.00+01:00”/>

<RecordRequestSuccess crid=“crid://zzz.com/movie/title1”

requestId=“156WQ77”
recordEndTime=“2003-04-07T20:30:00.00+01:00”
keepDuration=“PT24H” recordCost=“2” currency=“USD”/>

<RecordRequestFailure crid=“crid://ch1.com/serie/ep12”

KOreason=“unknownCRID”/>

<RecordRequestFailure crid=“crid://chaine5.com/film15”

KOreason=“unavailableServiceURL”/>

</TV_Record_Service_Request_Response>

</submit_Data_Result>

</Body>

</Envelope>

The same procedure is used to encapsulate other requests defined in the preceding embodiment for other steps of recording audiovisual content in the network.

1. A method of recording audiovisual content in a communications network including at least one network recorder able to record audiovisual content broadcast on a plurality of broadcast channels, characterized in that said audiovisual content is recorded by a network recorder at the request of a user having a communications terminal able to exchange information with at least one network recorder via said communications network, said method comprising the following steps:
the network recorder declaring itself in the network, the declaration indicating at least:
a means of access to said recorder,
a list of broadcast channels whose broadcast audiovisual content can be recorded by the network recorder,
the user using a terminal to select a network recorder able to record at least one required audiovisual content and to connect thereto using said access means in order to request the recording of said at least one audiovisual content, said request including an identification of said at least one audiovisual content to be recorded that consists in a unique reference of said content and/or an identification of an instance of said content consisting of at least the identification of the broadcast channel of said instance accompanied by the indication of a broadcast time band, and
the network recorder sending a response to the user's recording request containing, if the request is accepted, an identification of the accepted recording request for each content to be recorded.

2. A method according to claim 1, characterized in that it also includes the steps of:
for the user, if the request is accepted, sending the network recorder a recording request status request indicating at least said identification of the accepted recording request, and
for the network recorder, sending a response to the recording request status request containing at least the identification of the accepted recording request and the status of the request.

3. A method according to claim 1, characterized in that it also includes the steps consisting in the user formulating a request to cancel an accepted recording request or to delete a content recorded by the network recorder, indicating at least the identification of the accepted recording request.

4. A method according to any one of claims 1 to 3, characterized in that said means of access to a network recorder consist in an address of said recorder in the network.

5. A method according to any one of claims 1 to 3 characterized in that said means of access to a network recorder consists in a directory listing operations specific to the network recorders, each network recorder being identified by said operation.

6. A method according to any one of claims 1 to 5, characterized in that said list of broadcast channels whose broadcast audiovisual content can be recorded by the network recorder contains the address of each of the broadcast channels, optionally accompanied by the charging policy of the network recorder for each of the broadcast channels.

7. A method according to any one of claims 1 to 6, characterized in that the declaration of the network recorder in the network contains the conversion capabilities of said recorder.

8. A method according to claim 7, characterized in that said conversion capabilities concern bit rate reduction and/or transcoding of the audiovisual content.

9. A method according to any one of claims 1 to 8, characterized in that the declaration of the network recorder in the network contains the protocols that the network recorder can use to transfer the recorded audiovisual content to the user's terminal.

10. A method according to any one of claims 1 to 9, characterized in that said time band indication contains the broadcast start time and the broadcast end time or the duration of broadcasting on the broadcast channel of said instance.

11. A method according to any one of claims 7 to 10, characterized in that said request contains the conversion capabilities required by the user for transferring the recording to the user's terminal.

12. A method according to any one of claims 1 to 11, characterized in that, if the request is accepted, the response from the network recorder contains said unique reference of the requested audiovisual content.

13. A method according to any one of claims 1 to 12, characterized in that, if the request is accepted, the response from the network recorder contains the scheduled end of recording time and/or the cost of said recording.

14. A method according to any one of claims 1 to 13, characterized in that, if the request is accepted, the response from the network recorder contains the time for which the network recorder will keep the recording.

15. A method according to any one of claims 1 to 14, characterized in that, if the request fails, the response from the network recorder contains the reason for failure.

16. A method according to any one of claims 2 to 15, characterized in that said recording request status request contains said unique reference of the content and/or the identifier of the user.

17. A method according to any one of claims 2 to 16, characterized in that, if the request has not yet been executed, the response to the recording request status request contains the unique reference of the content and/or the scheduled end date and time.

18. A method according to any one of claims 2 to 16, characterized in that, in the case of an unknown request, the response to the recording request status request contains the unique reference of the content.

19. A method according to any one of claims 2 to 16, characterized in that, if the request fails, the response to the recording request status request contains the unique reference of the content.

20. A method according to any one of claims 2 to 16, characterized in that, if the recorded content is available, the response to the recording request status request contains an address at which the recorded content is available.

21. A method according to claim 20, characterized in that said response contains the unique reference of the content and/or the time for which the network recorder will keep the recording.

22. A method according to any one of claims 3 to 21, characterized in that said request to cancel the recording request or to delete the recorded content contains the unique reference of the content and/or the identifier of the user.

23. A method according to any one of claims 1 to 22, characterized in that said request contains an identification of the user.

24. A method according to any one of claims 1 to 23, characterized in that, if the request fails and a plurality of contents has been requested, the response from the network recorder to the user's recording request contains an identifier of the content for which the request has failed.
